(19) United States
(12) Patent Application Publication
(10) Pub. No.: US 2024/0292305 A1
(43) Pub. Date: Aug. 29, 2024

(54) METHOD AND APPARATUS SUPPORTING SELF-CONFIGURATION AND SELF-OPTIMIZATION

(71) Applicant: Samsung Electronics Co., Ltd., Suwon-si (KR)

(72) Inventors: Lixiang XU, Beijing (CN); Weiwei WANG, Beijing (CN); Hong WANG, Beijing (CN)

(21) Appl. No.: 18/584,923

(22) Filed: Feb. 22, 2024

(30) Foreign Application Priority Data
Feb. 24, 2023 (CN) 202310192017.0
Jul. 27, 2023 (CN) 202310930858.7
Sep. 21, 2023 (CN) 202311229374.6
Nov. 8, 2023 (CN) 202311485034.X

(51) Int. Cl. H04W 36/30; H04W 36/00; H04W 76/20

(52) U.S. Cl. CPC H04W 36/305; H04W 36/0061; H04W 76/20

(57) ABSTRACT

The disclosure relates to a 5G or 6G communication system for supporting a higher data transmission rate. The present disclosure provides a method and an apparatus supporting self-configuration and self-optimization.

### CROSS-REFERENCE TO RELATED APPLICATION(S)

This application is based on and claims priority under 35 U.S.C. § 119 to Chinese Patent Application No. 202310192017.0 filed Feb. 24, 2023, Chinese Patent Application No. 202310930858.7 filed Jul. 27, 2023, Chinese Patent Application No. 202311229374.6 filed Sep. 21, 2023, and Chinese Patent Application No. 202311485034.X filed Nov. 8, 2023 in the Chinese Intellectual Property Office, the disclosures of which are incorporated by reference herein in their entirety.

### BACKGROUND

### 1. Field

The present application relates to wireless communication technologies, and in particular, to a method and an apparatus supporting self-configuration and self-optimization.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

Wireless communication is one of the most successful innovations in modern history. Recently, the number of subscribers to wireless communication services have exceeded 5 billion and continues to grow rapidly. The demand for wireless data services is growing rapidly due to the increasing popularity of smartphones and other mobile data devices (e.g., tablets, notebook computers, netbooks, e-book readers, and machine-type devices) among consumers and businesses. In order to meet the rapid growth of mobile data services and support new applications and deployments, it is critical to improve efficiency and coverage of wireless interfaces.

### SUMMARY

The present disclosure relates to a wireless communication system and, more specifically, the present disclosure relates to supporting self-configuration and self-optimization.

According to one aspect of the present disclosure, a method performed by a terminal in a wireless communication system is provided. The method may include storing a successful handover report including information on a cell radio network temporary identifier (C-RNTI) assigned by a target cell of a handover, in case that the handover is completed; identifying that a radio link failure (RLF) is detected; storing, by the UE, radio link failure information based on the RLF, the radio link failure information including the C-RNTI assigned by the target cell; receiving, from a base station, a user equipment (UE) information request message; and transmitting, to the base station, a UE information response message including at least one of the successful handover report or the radio link failure information, based on a reception of the UE information request message.

According to another aspect of the present disclosure, a method performed by a first base station associated with a target cell in a wireless communication system is provided. The method may include receiving, from a second base station, a first message including a radio link failure (RLF) report, in case that radio link failure information is transmitted to the second base station; detecting a cause for a RLF based on the first message; and transmitting, to a third base station, a handover report including at least one of information on a cell radio network temporary identifier (C-RNTI) assigned by the target cell, or information indicating a time elapsed since the RLF is detected.

According to another aspect of the present disclosure, a method performed by a second base station in a wireless communication system is provided. The method may include transmitting, to a terminal, a user equipment (UE) information request message; receiving, from the terminal, a UE information response message including at least one of successful handover report or radio link failure information, based on the UE information request message—the successful handover report including information on a cell radio network temporary identifier (C-RNTI) assigned by a target cell of a handover in case that the handover is completed, and the radio link failure information including the C-RNTI assigned by the target cell; transmitting, to a first base station, a first message including a radio link failure (RLF) report including the radio link failure information; identifying whether the successful handover report is associated with the first base station or a third base station; and transmitting, to the first base station, a second message including a radio link failure (RLF) report including the successful handover report, in case that the successful handover report is associated with the first base station.

According to another aspect of the present disclosure, a terminal in a wireless communication system is provided. The terminal may include a transceiver; and at least one processor configured to: store a successful handover report including information on a cell radio network temporary identifier (C-RNTI) assigned by a target cell of a handover, in case that the handover is completed, identify that a radio link failure (RLF) is detected, store, by the UE, radio link failure information based on the RLF, the radio link failure information including the C-RNTI assigned by the target cell, receive, from a base station via the transceiver, a user equipment (UE) information request message, and transmit, to the base station, a UE information response message including at least one of the successful handover report or the radio link failure information, based on a reception of the UE information request message.

According to another aspect of the present disclosure, a first base station associated with a target cell in a wireless communication system is provided. The first base station associated with a target cell may include a transceiver; and at least one processor configured to: receive, from a second base station via the transceiver, a first message including a radio link failure (RLF) report, in case that radio link failure information is transmitted to the second base station, detect a cause for a RLF based on the first message, and transmit, to a third base station via the transceiver, a handover report including at least one of information on a cell radio network temporary identifier (C-RNTI) assigned by the target cell, or information indicating a time elapsed since the RLF is detected.

According to another aspect of the present disclosure, a second base station in a wireless communication system is provided. The second base station may include a transceiver; and at least one processor configured to: transmit to a terminal via the transceiver, a user equipment (UE) information request message, receive, from the terminal via the transceiver, a UE information response message including at least one of successful handover report or radio link failure information, based on the UE information request message—the successful handover report including information on a cell radio network temporary identifier (C-RNTI) assigned by a target cell of a handover in case that the handover is completed, and the radio link failure information including the C-RNTI assigned by the target cell, transmit, to a first base station, a first message including a radio link failure (RLF) report including the radio link failure information, identify whether the successful handover report is associated with the first base station or a third base station, and transmit, to the first base station, a second message including a radio link failure (RLF) report including the successful handover report, in case that the successful handover report is associated with the first base station.

According to an embodiment of present disclosure, a terminal can efficiently perform a communication.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system architecture for system architecture evolution (SAE);

FIG. 2 illustrates an initial overall architecture of a 5G system;

FIG. 3 illustrates a flowchart of a first method in accordance with an embodiment of the present disclosure;

FIG. 4 illustrates a flowchart of a second method in accordance with an embodiment of the present disclosure;

FIG. 5 illustrates a network node in accordance with an embodiment of the present disclosure; and

FIG. 6 illustrates a UE in accordance with an embodiment of the present disclosure.

### DETAILED DESCRIPTION

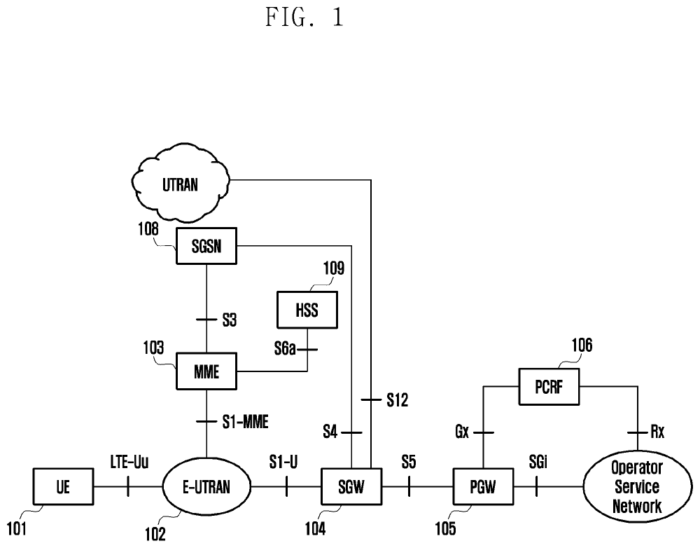

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In order to make the purposes, technical solutions and advantages of the present disclosure clearer, technical solutions according to embodiments of the present disclosure are described clearly and completely with reference to the accompanying drawings of the embodiments of the present disclosure. It is apparent that the embodiments described herein are not exhaustive and merely part of the embodiments of the present disclosure. Based on the embodiments of the present disclosure described herein, all other embodiments obtained by those of ordinary skill in the art without creative work shall fall within the protection scope of the present disclosure.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communications. The terms “include” and “contain,” as well as derivatives thereof, mean inclusion without limitation. The term “or” is inclusive, meaning “and/or.” The phrase “associated with,” as well as derivatives thereof, means to include, be included within, connected to, interconnect with, contain, be contained within, connect to or with, couple to or with, be communicable with, cooperate with, interleave with, juxtapose with, be proximate to, be bound to or with, have, have a property of, have a relationship to or with, or the like. The term “controller” means any device, system or a part thereof that controls at least one operation. Such a controller may be embodied in hardware, or in a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any one of the following combinations: A, B, C, A and B, A and C, B and C, and A and B and C. For example, “at least one of A, B, or C” includes any one of the following combinations: A, B, C, A and B, A and C, B and C, and A and B and C.

Moreover, various functions described below may be implemented or supported by one or more computer programs, each of which is formed from computer readable program codes and embodied in a computer readable medium. The terms “application” and “program” refer to one or more computer programs, software components, sets of instructions, procedures, functions, objects, classes, instances, related data, or a portion thereof adapted for implementation in suitable computer readable program codes. The phrase “computer readable program code” includes any type of computer code, including a source code, an object code, and an executable code. The phrase “computer readable medium” includes any type of medium capable of being accessed by a computer, such as read-only memory (ROM), random access memory (RAM), a hard disk drive, an optical disc (CD), a digital video disk (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The terms used herein for describing the embodiments of the present application are not intended to limit and/or define the scope of the present application. For example, unless otherwise defined, technical terms or scientific terms used in the present disclosure should have the general meanings as understood by persons with ordinary skills in the art.

It may be understood that the words “first,” “second” and similar words used in the present disclosure do not indicate any order, number or importance, but are only used to distinguish different components. Unless otherwise clearly indicated by the context, singular words such as “one,” “a” or “the” do not imply a quantitative limit, but rather is used to indicate “at least one.”

As used herein, any reference to “an example” or “examples,” “an embodiment” or “embodiments” means that a particular element, feature, structure or characteristic described in combination with that embodiment is included in at least one embodiment. The phrases “in one embodiment” or “in one example” in different places herein do not necessarily refer to the same embodiment.

As used herein, “a part” of a thing means “at least some” of that thing, and therefore may mean less than the whole thing or all of the thing. Thus, a “part of” of a thing includes the whole thing as a special case, i.e., an example where the whole thing is a part of the thing.

It may be further understood that the term “include” or “contain” and the like mean that the element or object precede the word covers the elements or objects listed after the word and their equivalents, without excluding other elements or objects. Words such as “connection” or “connected” are not limited to physical or mechanical connections, but may include electrical connections, whether direct or indirect. The words “up,” “down,” “left,” “right,” and the like are only used to represent relative position relationships, and when the absolute positions of the described objects change, the relative position relationship may also change accordingly.

The various embodiments used to describe the principles of the present disclosure herein that will be discussed below are for illustration only and should not be construed in any way to limit the scope of the disclosure. Those skilled in the art may understand that the principles of the present disclosure may be implemented in any suitably arranged wireless communication system. For example, although embodiments of the present disclosure are described below in detail with respect to LTE and 5G communication systems, those skilled in the art may understand that without substantially departing from the scope of the present disclosure, the main points of the present disclosure may also be applied to other communication systems having a similar technical background and channel format with minor modifications. The technical solution of the embodiments of the present application may be applied to various communication systems. For example, the communication system may include a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunication system (UMTS) system, a worldwide interoperability for microwave access (WiMAX) communication system, a 5th generation (5G) system or a new radio (NR) system. Furthermore, the technical solution of the embodiments of the present application may be applied to future communication technologies. Furthermore, the technical solution of the embodiments of the present application may be applied to future communication technologies.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. In addition, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIGS. 1 to 5 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 illustrates an exemplary system architecture of system architecture evolution (SAE). A user equipment (UE) 101 is a terminal device for receiving data. An evolved universal terrestrial radio access network (E-UTRAN) 102 is a radio access network, which includes a macro base station (eNodeB/NodeB) that provides the UE with interfaces to access a radio network. A mobility management entity (MME) 103 is responsible for managing mobility context, session context and security information of the UE. A serving gateway (SGW) 104 mainly provides functions of a user plane, and the MME 103 and the SGW 104 may be in a same physical entity. A packet data network gateway (PGW) 105 is configured to provide functions such as charging and lawful interception and may also be in a same physical entity as the SGW 104. A policy and charging rules function entity (PCRF) 106 provides a Quality of Service (QoS) policy and a charging standard. A general packet radio service support node (SGSN) 108 is a network node device in a universal mobile telecommunications system (UMTS) that provides routing for data transmission. A home subscriber server (HSS) 109 is a home subsystem of the UE and is configured to protect user information including a current location of the user equipment, an address of the serving node, user security information, and a packet data context of the user equipment, and the like.

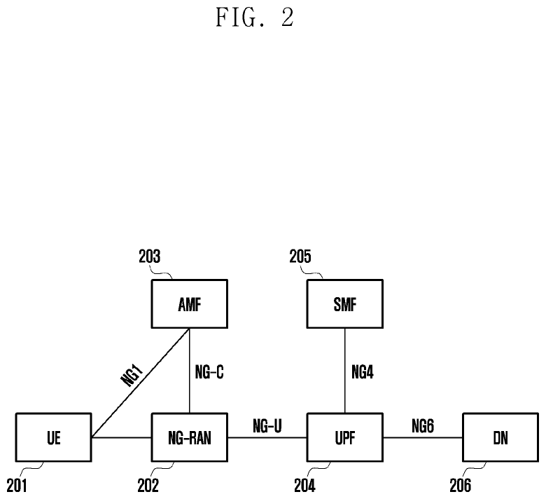

FIG. 2 illustrates an example system architecture 200 in accordance with various embodiments of the present disclosure. Other embodiments of the system architecture 200 can be used without departing from the scope of the present disclosure.

A user equipment (UE) 201 is a terminal device configured to receive data. A next generation radio access network (NG-RAN) 202 is a radio access network that includes a base station (gNB or eNB connected to a 5G core network 5GC, also referred to as an ng-gNB) that provides the UE with an interface to the radio network. An access control and mobility management function (AMF) 203 is configured to manage a mobility context and security information of the UE. A user plane function entity (UPF) 204 mainly provides functions of a user plane. A session management function entity SMF 205 is configured for session management. A data network (DN) 206 includes for example services of carriers, Internet access, and third-party services.

The exemplary embodiments of this disclosure are further described below in conjunction with the accompanying drawings.

The text and drawings are provided as examples only to help understand the present disclosure. They should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Supporting the mobility robustness of handover for voice fallback becomes a problem that needs to be solved.

The present disclosure supports a self-configuration self-optimization method that in case of a potential handover failure or a handover failure or a failure after a successful handover, may correctly identify causes for such potential failure or failure and carry out proper optimization accordingly, reducing failures, ensuring service continuity, and reducing the labour cost of the operator. Furthermore, in case that a potential failure and a failure occur at the same time in a successful handover, a network end may correlate such potential failure and the failure for a same UE and perform proper optimization, reducing failures, ensuring service continuity, and reducing the labour cost of the operator.

It may be appreciated by those skilled in the art that the “timer” as used in the present disclosure may also be referred to as a time clock or time counter, and these terms are used interchangeably in the present disclosure.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

The NR and LTE in the following description are only examples of various radio access technologies (RAT), and there may also be other RATs, and the present disclosure is not limited thereto.

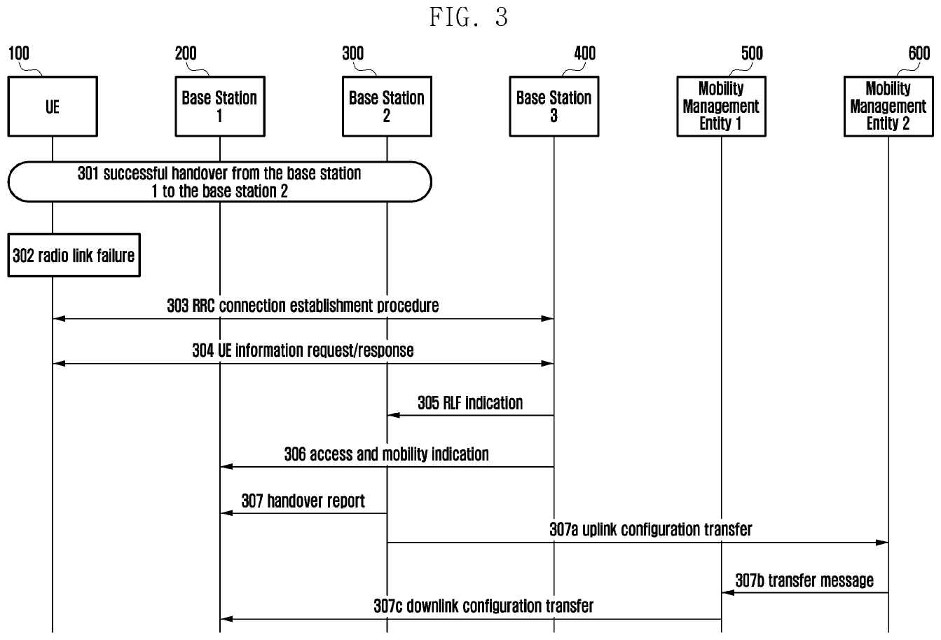

An example of a first method supporting self-configuration and self-optimization in accordance with the present disclosure is shown in FIG. 3. The method includes the following steps.

In one example of Step 301, a base station 1 (200) hands over a UE (100) to a base station 2 (300). The base station 1 (200) and the base station 2 (300) are base stations that support the same radio access technologies, base stations that support different radio access technologies or base stations for different systems. For example, the base station 1 (200) is a base station that supports NR, and the base station 2 (300) is an LTE base station or an E-UTRAN base station or an LTE base station connected to a 5G core network, or an NR base station. The handover process is completed successfully.

The condition for triggering a successful handover report is met, and the UE (100) stores the successful handover report (SHR). The successful handover report may include at least one of a cell radio network temporary identifier (C-RNTI) assigned by a target cell to the UE (100) and/or a C-RNTI assigned by a source cell to the UE (100). The successful handover report may include a time since the handover command to the reporting of the successful handover report. The time since the handover command to the reporting of the successful handover report may also referred as a time since the time when the latest RRC connection reconfiguration message containing a mobility control information is received to the successful handover report retrieval or a time since the handover command to the UE information request message requesting the SHR. The handover command is the latest handover command. The successful handover report comprises information of the source cell and information of the target cell. The information of the source cell comprises global cell identifier information of the source cell. The information of the target cell comprises global cell identifier information of the target cell. The global cell identifier information comprises a global cell identifier and a tracking area code.

In one example of Step 302, the UE (100) may encounter radio link failure (RLF) in a cell of the base station 2 (300). The UE (100) may store the radio link failure information. The UE (100) may store the radio link failure information in an RLF report variable.

The radio link failure information may include at least one of a C-RNTI assigned by a target cell to the UE (100) and/or a C-RNTI assigned by a source cell to the UE (100). The radio link failure information further includes at least one of cell Identifier information of a cell where the failure happens, cell Identifier information of the previous primary cell, Identifier information of the previous NR primary cell, cell Identifier information of the re-establishment cell, cell Identifier information of the reconnect cell, the type of failure, a time since the receipt of the RRC reconfiguration message containing the handover command to the failure, a time since the failure to the completion of the RRC reconnection, measurement results of a serving cell, measurement results of a neighboring cell, suitable cell Identifier information, and/or a time since the failure to the time transmitting the RLF report to the base station. The previous primary cell and/or the previous NR primary cell are source cells of the last handover prior to the failure. The time since the failure to the time transmitting the RLF report to the base station may also be the time since the failure to time reporting the RLF report or the time since the failure to time when UE (100) receives the UE information request.

The cell Identifier information includes at least one of a global cell identifier, a tracking area code where the cell is located, a physical cell identifier, and/or frequency information.

In one example of Step 303, the UE (100) may connect to a base station 3 (400). The UE (100) may transmit an RRC connection request or an RRC connection reestablishment request message to the base Station 3 (400). The base station 3 (400) may transmit an RRC connection establishment message or an RRC connection reestablishment request message to the UE (100). The UE (100) may transmit an RRC connection establishment complete message or an RRC connection reestablishment complete message to the base station 3 (400). Alternatively, the UE (100) may be connected to the base station 3 (400) through a handover process. The UE (100) may transmit an RRC reconfiguration complete message to the base station 3 (400).

If the UE (100) has a successful handover report stored, the RRC connection establishment complete message or the RRC connection reestablishment complete message or the RRC reconfiguration complete message includes successful handover report information available. If there is successful handover information in the successful handover report variable and a registered PLMN is included in a list of PLMN identifiers stored in the successful handover report variable, the UE (100) may include successful handover information available in the RRC connection establishment complete message or RRC connection reestablishment complete message or RRC reconfiguration complete message.

If radio link failure information or handover failure information exists in the RLF report variable and the registered PLMN is included in a list of PLMN identifiers stored by the RLF reporting variable, Identifier information of the suitable cell or Identifier information of the reconnect cell or Identifier information of the re-establishment cell is included in the RLF report variable.

If the UE (100) may support the mobility robustness (MRO) RLF report of inter radio access technologies (inter-RAT), and radio link failure information or handover failure information exists in the RLF report variable and the registered PLMN is included in a list of PLMN identifiers stored by the RLF reporting variable, Identifier information of the suitable cell or Identifier information of the reconnect cell or Identifier information of the re-establishment cell is included in the RLF report variable.

When a re-establishment process is initiated after a handover from NR fails, Identifier information of the re-establishment cell is included in the RLF report.

The Identifier information of the suitable cell or the Identifier information of the reconnected cell includes a global cell identifier and/or a tracking area code (TAC) of the cell. The suitable cell or reconnected cell is the cell that is suitable for access by the UE (100) after the failure or the cell to which the UE (100) is reconnected successfully. The cell in which the reconnection is successful contains a cell in which the UE successfully completes the RRC reconnection process or a cell in which the UE successfully completes the RRC connection establishment process.

The RRC connection establishment complete message or the RRC connection reestablishment complete message or the RRC reconfiguration complete message includes RLF information available. If the radio link failure or handover failure information is in the RLF report variable and a registered PLMN is included in a list of PLMN identifiers stored in the RLF report variable, the RRC connection establishment complete message or RRC connection reestablishment complete message or RRC reconfiguration complete message includes RLF information available.

In one example of Step 304, the base station 3 (400) may transmit a UE information request message to the UE (100). The base station 3 (400) may transmit a UE information request message to the UE (100) after receiving the information that the successful handover information and/or the RLF information is available.

The UE (100) may transmit a UE information request response message to the base station 3 (400). The UE information response message includes at least one of a successful handover report and/or an RLF report. The RLF report may include the same content as described in step 302, which is omitted herein. The information contained in the successful handover report are as same as that described in step 301, which will not be further described herein.

The cell Identifier information includes at least one of a global cell identifier, a tracking area code where the cell is located, a physical cell identifier, and/or frequency information.

Measurement results of a serving cell or a neighbor cell include measurements of an NR cell, an E-UTRA cell and another radio access technology cell, which is not limited in the present disclosure.

With respect to handover failure from an NR base station to an E-UTRA base station, the base station 3 (400) may be an NR base station or an E-UTRA base station. With respect to failure after completion of the handover from an NR to an E-UTRA, when the base station 3 (400) is an NR base station, the UE information response message contains Identifier information of the last serving cell, and the Identifier information of the last serving cell is included in the UE information response message outside the RLF report. The Identifier information of the last serving cell is the Identifier information of the target cell serving the UE in the base station 2 (300). In this way, when the base station 3 (400) receives the UE information response message, it may know the base station 2 (300) according to the Identifier information of the last serving cell without parsing the RLF report encoded according to the E-UTRA RRC format, so as to forward the RLF report received from the UE (100) to base station 2 (300). The base station 3 (400) may transmit an RLF report received from the UE (100) to the base station 2 (300) through an inter-base interface message or through a core network.

The UE (100) may transmit a successful handover report and an RLF report to different base stations, for example, a successful handover report to the base station 3 (400) and an RLF report to the base station 4 (not shown). Specifically, the method for the UE (100) to indicate to the base station 4 that the radio link failure information is available and transmit an RLF report to the base station 4 is the same as the method for transmitting to the base station 3 (400) in steps 304 and 304 above.

In one example of Step 305, the base station 3 (400) may transmit a received RLF report to the base station of the cell where the failure occurs. The base station where the failure occurs is the base station 2 (300). The base station 3 (400) may be a base station that supports the same radio access technology as the base station 2 (300) or a base station that supports a different radio access technology, and the base station 3 (400) may be a base station in the same system or a base station under a different system from the base station 2 (300).

The base station 3 (400) may transmit an RLF report received from the UE (100) to the base station 2 (300) through an inter-base station interface or transmits an RLF report received from the UE (100) to the base station 2 (300) through a core network.

If the base station 3 (400) and the base station 2 (300) are base stations under a same system, for example, both are E-UTRAN base stations, the base station 3 (400) may transmit an RLF report to the base station 2 (300) through an RLF indication message of the inter-base station interface. The base station 3 (400) may also transmit an RLF report to the base station 2 (300) through another inter-base station interface message.

If there is no interface between the base station 3 (400) and the base station 2 (300) or the base station 3 (400) and the base station 2 (300) are base stations of different systems, the base station 3 (400) transmits an RLF report to the base station 2 (300) through a core network. If the base station 3 (400) and the base station 2 (300) are base stations of different systems or base stations of different radio access technologies, the base station 3 (400) knows the base station 2 (300) according to the cell Identifier information of the cell where the failure happens received from the RRC message, thereby transmitting the received RLF report to the base station 2 (300).

In case that the UE (100) transmits the RLF report to the base station 4, the base station 4 transmits the received RLF report to the base station 2 (300). The specific operation of the base station 4 is the same as the above base station 3 (400), which will not be described again here.

The base station 2 (300) may detect a cause for the failure.

For an intra-system handover, if there is a recent handover prior to the failure, and the first reestablishment attempt cell or successfully reconnect cell is the cell that serves the UE (100) at the last handover initialization, then the handover is an intra-system too early handover.

For an intra-system handover, if there is a recent handover prior to the failure, and the first reestablishment attempt cell or the cell the UE (100) attempts to re-connect or the cell the UE (100) attempts CHO recovery is not the cell that serves the UE (100) at the latest handover initialization, then the handover is an intra-system handover to wrong cell.

For an inter-system handover, if the connection failure occurs while the UE (100) being connected to a radio access network (RAN) node in an access system, and there is a recent inter-system handover prior to the failure, and the node of the first cell where the UE (100) attempts to reconnect and the node that served the UE (100) at the last handover initialization are RAN nodes of the same system, the handover is a too early inter-system handover. For example, a failure occurs while the UE (100) being connected to an E-URATN node, there is a recent inter-system handover from an NG-RAN node to an E-UTRAN node prior the failure, and the first cell where the UE (100) attempts to re-connect after the failure is the cell controlled by the NG-RAN node, then the handover from the NG-RAN to the E-UTRAN is a too early handover.

The base station 2 (300) may transmit a handover report to a source base station, where the source base station is the base station 1 (200).

The message may be transmitted by the base station 2 (300) to the base station 1 (200), or the message transmitted by the base station 2 (300) to the core network includes the C-RNTI of the UE (100) in the source cell, the C-RNTI of the UE (100) in the target cell, a time since the time when the UE (100) may receive the latest handover command to the failure, a time since the connection failure to the reporting of the RLF report, a time since the time when the UE (100) receives the latest handover command to the RLF report retrieval, the cell identifier of the source cell, the cell identifier of the target cell, and/or a time since the failure to completion of RRC reconnection. The time since the time when the UE (100) receives the latest handover command to the failure may also be referred to the time since the initialization of the last handover to the failure, or from the receipt of the latest RRC connection reconfiguration message containing mobility control information to the failure or from the receipt of the latest RRC connection reconfiguration message containing the handover command to the failure.

The time since the connection failure to the reporting of the RLF report may also be referred to the time since the connection failure to the transmitting of the RLF report to the base station or from the connection failure to the receipt of the UE information request or from the latest connection failure to the transmitting the UE information response message containing the RLF report to the base station. The connection failure may be a handover failure or a radio link failure. The base station 2 (300) may include the C-RNTI of the UE (100) in the source cell, and/or the C-RNTI of the UE in the target cell, and/or the time since the time when the UE (100) receives the latest handover command to the failure, and/or the time since the connection failure to the reporting of the RLF report, and/or the time since the failure to the completion of RRC reconnection, and/or the cell identifier of the source cell, and/or the cell identifier of the target cell contained in the RLF report, into an inter-base station interface message transmitted to base station 1 (200) or a message transmitted to the core network.

The base station 2 (300) knows the time since the time when the UE (100) receives the latest handover command to the reporting the RLF report, according to the time since the time when the UE (100) receives the latest handover command to the failure and the time since the connection failure to the reporting the RLF report contained in the RLF report. The time since the time when the UE (100) receives the latest handover command to reporting the RLF report is the time since the time when the UE (100) receives the latest handover command to failure, plus the time since failure to reporting the RLF report. The C-RNTI of the UE (100) in the source cell, and/or the C-RNTI of the UE in the target cell, and/or the time since the time when the UE (100) receives the latest handover command to the failure, and/or the time since the connection failure to the reporting of the RLF report, and/or the time since the failure to the completion of RRC reconnection, and/or the time since the time when the UE (100) receives the latest handover command to the reporting the RLF report, and/or the cell identifier of the source cell, and/or the cell identifier of the target cell are contained outside an RLF report container in an inter-base station interface message transmitted to the base station 1 (200) or in a message transmitted to the core network.

In this way, the base station 1 (200) can know the C-RNTI of the UE (100) in the source cell, and/or the C-RNTI of the UE (100) in the target cell, and/or the time since the time when the UE (100) receives the latest handover command to the failure, and/or the time since the connection failure to the reporting of the RLF report, and/or the time since the failure to the completion of RRC reconnection, and/or the time since the time when the UE (100) receives the latest handover command to RLF report retrieval, and/or the cell identifier of the source cell, and/or the cell identifier of the target cell, without parsing the RLF report encoded in an RRC format supported by the base station 2 (300). The base station 2 (300) may also include another information element in the RLF report into the handover report or uplink configuration transfer message transmitted to the base station 1 (200), the information element is included outside the RLF report, so that the base station 1 (200) may obtain the corresponding information without parsing the RLF report encoded according to an RRC format supported by the base station 2 (300).

In one example of Step 306, if the base station 3 (400) receives a successful handover report and the cause for the successful handover report is T310 and/or T312, the base station 3 (400) transmits the successful handover report received to source base station of the corresponding handover, where the source base station of the corresponding handover is the base station 1 (200). The base station 3 (400) may transmit a received successful handover report to the base station 1 (200) by an access and mobility indication messages or another message.

If the base station 3 (400) receives a successful handover report and the cause for the successful handover report is T304, the base station 3 (400) transmits the successful handover report received to the corresponding target base station for the handover, where the target base station for the handover is the base station 2 (300). The base station 3 may transmit a received successful handover report to the base station 2 (300) by an access and mobility indication messages or another message.

The base station 3 (400) may also include the C-RNTI of the UE (100) in the source cell or the C-RNTI of the UE (100) in the target cell and/or the time since the handover command to the reporting of the SHR contained in the successful handover report into a message transmitted to the base station 2 (300) or the base station 1 (200), so that even if the base station 2 (300) or the base station 1 (200) does not parse the successful handover report, the base station may also know the C-RNTI of the UE (100) in the source cell or the C-RNTI of the UE (100) in the target cell or the time since the handover command to the reporting of the SHR, so as to know that the successful handover report and the RLF report are for the same UE. The base station 3 (400) may also include another information element in the successful handover report in the message transmitted to the base station 2 (300) or the base station 1 (200), so that even if the base station 2 (300) or the base station 1 (200) does not parse the successful handover report, the corresponding information can be obtained.

To correlates the successful handover report and the RLF report described in the present disclosure refers to confirming that the successful handover report and the RLF report are for the same UE, or confirming that the successful handover report and the RLF report are for the same UE the same handover, or confirming that the successful handover report and the RLF report are for the same event. If the successful handover report and the RLF report are for the same event, then the successful handover report can be ignored and only the RLF report is considered.

In the present disclosure, the successful handover report and the RLF report described are correlated indicates that the successful handover report and the RLF report are for the same UE, or that the successful handover report and the RLF report are for the same UE the same handover, or that the successful handover report and the RLF report are for the same event.

The base station 2 (300) may receive the successful handover report and the RLF report, and the base station 2 (300) may correlate the successful handover report and the RLF report if the C-RNTI of the UE (100) in the target cell contained in the successful handover report and the C-RNTI of the UE (100) in the target cell in the RLF report are the same. Alternatively, the base station 2 (300) may correlate the successful handover report and the RLF report if the C-RNTI of the UE (100) in the target cell contained in the message containing the successful handover report and the C-RNTI of the UE (100) in the target cell contained in the RLF report are the same. Alternatively, the base station 2 (300) may correlate the successful handover report and the RLF report as the C-RNTI of the UE (100) in the source cell contained in the message containing the successful handover report and the C-RNTI of the UE (100) in the source cell contained in the RLF report are the same.

Alternatively, the base station 2 (300) may correlate the successful handover report and the RLF report as the C-RNTI of the UE (100) in the source cell contained in the message containing the successful handover report and the C-RNTI of the UE (100) in the source cell contained in the UE (100) context are the same. Alternatively, the base station 2 (300) may correlate the successful handover report and the RLF report as the C-RNTI of the UE (100) in the source cell contained in the successful handover report and the C-RNTI of the UE (100) in the source cell contained in the UE context are the same. Alternatively, the base station 2 (300) may correlate the successful handover report and the RLF report as the C-RNTI of the UE (100) in the source cell contained in the successful handover report and the C-RNTI of the UE (100) in the source cell contained in the RLF report are the same.

Alternatively, the base station 2 (300) may correlate the successful handover report and the RLF report according to the C-RNTI of the UE (100) in the target cell contained in the successful handover report, the time since the handover command to the reporting of the SHR contained in the successful handover report, the C-RNTI of the UE (′00) in the target cell contained in the RLF report, the time since the time when the UE (100) receives the latest handover command to the failure and/or the time since the connection failure to the reporting of the RLF report contained in the RLF report, thereby knowing that the successful handover report and the RLF report are for the same UE and the same handover. Alternatively, the base station 2 (300) may correlate the successful handover report and the RLF report according to the C-RNTI of the UE in the source cell contained in the successful handover report, the time since the handover command to the reporting of the SHR contained in the successful handover report, the C-RNTI of the UE (100) in the source cell contained in the RLF report, and/or the time since the time when the UE (100) receives the latest handover command to the failure and the time since the connection failure to the reporting of the RLF report contained in the RLF report, thereby knowing that the successful handover report and the RLF report are for the same UE and the same handover.

The base station 2 (300) also needs to take into account that the target cell contained in the successful handover report and the target cell or the cell where the failure happens contained in the RLF report are the same cell. If the target cell contained in the successful handover report and the target cell or the cell where the failure happens contained in the RLF report are the same cell, then considering the above factors, it is determined that the successful handover report and the RLF report are for the same event.

The base station 2 (300) may know that the RLF report and the successful handover report are correlated and that they are for the same UE and the same handover as the C-RNTI of the UE (100) in the source cell contained in the successful handover report is the same as the C-RNTI of the UE (100) in the source cell received in step 305, and according to the time since the handover command to the reporting the SHR contained in the successful handover report, and the time since the handover command to the failure and the time since the connection failure to the reporting the RLF report, received in step 305, thereby performing suitable optimization. The base station 2 (300) may know the time since the handover command to the reporting of the RLF according to the time since the handover command to the failure and the time since the connection failure to the reporting of the RLF report, received in step 305.

The base station 2 (300) may know the time when the handover corresponding to the RLF report occurs according to the time since the handover command to the reporting of the RLF. The base station 2 (300) may know the time when the handover corresponding to the SHR occurs according to the time since the handover command to the reporting of the SHR. Based on the fact that the time when the handover corresponding to the RLF report occurs is the same as the time when the handover corresponding to the SHR occurs, and that the C-RNTI of the UE (100) in the source cell contained in the successful handover report is the same as the C-RNTI of the UE (100) in the source cell received in step 305, the base station 2 (300) may know that the RLF report and SHR are correlated, so as to perform proper optimization.

The time since the handover command to the reporting the RLF report is the time since the handover command to the failure, plus the time since the connection failure to the reporting the RLF report.

The base station 2 (300) may know that the RLF report and the successful handover report are correlated and that they are for the same UE and the same handover if the C-RNTI of the UE (100) in the target cell contained in the successful handover report is the same as the C-RNTI of the UE in the target cell received in step 305, and according to the time since the handover command to the reporting the SHR contained in the successful handover report, and the time since handover command to the failure and/or the time since the connection failure to the reporting the RLF report, received in step 305, thereby performing suitable optimization. The base station 2 (300) may know the time since the handover command to the reporting of the RLF according to the time since the handover command to the failure and the time since the connection failure to the reporting of the RLF report, received in step 305.

The base station 2 (300) may know the time when the handover corresponding to the RLF report occurs according to the time since the handover command to the reporting of the RLF. The base station 2 (300) may know the time when the handover corresponding to the SHR occurs according to the time since the handover command to the reporting of the SHR. Based on the fact that the time when the handover corresponding to the RLF report occurs is the same as the time when the handover corresponding to the SHR occurs, and that the C-RNTI of the UE (100) in the target cell contained in the successful handover report is the same as the C-RNTI of the UE (100) in the target cell received in step 305, the base station 2 knows that the RLF report and SHR are correlated, so as to perform proper optimization.

For successful handover reports caused by the T304 threshold, correlation is made by the target base station. For a successful handover report brought about by the T310 threshold and/or the T312 threshold, the correlation is made by the source base station, as described in step 307 or step 307c.

In one example of Step 307, for an intra-system handover, if the base station 2 (300) and the base station 1 (200) have interfaces, the base station 2 (300) transmits a handover report to the base station 1 (200) through an inter-base station interface. The handover report contains the C-RNTI of the UE (100) in the source cell and/or the C-RNTI of the UE (100) in the target cell.

When the base station 2 (300) and base station 1 (200) support different radio access technologies, for example, the base station 1 (200) is an NR base station, and the base station 2 (300) is an E-UTRA base station, for an RLF that occurs after a successful handover from the NR base station to the E-UTRA base station, the RLF report is in an LTE RRC format, and the base station 2 (300) includes the C-RNTI of the UE in the target cell contained in the RLF report in the handover report transmitted to base station 1 (200), and the C-RNTI of the UE in the target cell is included outside of the RLF report container in the handover report message, so that when the base station 1 (200) receives the handover report, the base station knows the C-RNTI of the UE (100) in the target cell without parsing the RLF report container in the RRC format supported by the base station 2 (300).

The C-RNTI of the UE (100) in the source cell is received from the source base station or received from the UE (100) by a handover request message. If the C-RNTI of the UE (100) in the source cell is received from the UE (100) through the RLF report, the base station 2 (300) includes the C-RNTI of the UE (100) in the source cell contained in the RLF report into the handover report transmitted to base station 1 (200), and the C-RNTI of the UE (100) in the source cell is included outside the RLF report container in the handover report message, so that when the base station 1 (200) receives the handover report, the base station knows the C-RNTI of the UE (100) in the source cell without parsing the RLF report container in the RRC format supported by the base station 2 (300).

The base station 2 (300) includes the time since the time when the UE (100) receives the latest handover command to the failure and/or the time since the connection failure to the reporting of the RLF report and/or the time since the failure to the completing the RRC reconnection, and/or the cell identifier of the source cell and/or the cell identifier of the target cell, contained in the RLF report, into the handover report transmitted to the base station 1 (200), the time since the time when the UE (100) receives the latest handover command to the failure and/or the time since the connection failure to the reporting of the RLF report and/or the time since the failure to the completing the RRC reconnection and/or the cell identifier of the source cell and/or the cell identifier of the target cell are included outside of the RLF report container in the handover report message, so that when the base station 1 (200) receives the handover report, the base station 1 (200) knows the time since the time when the UE (100) receives the latest handover command to the failure and/or the time since the connection failure to the reporting of the RLF report and/or the time since the failure to the completing the RRC reconnection and/or the cell identifier of the source cell and/or the cell identifier of the target cell, without parsing the RLF report container in RRC format supported by the base station 2 (300).

The base Station 2 (300) may include the time since the time when the UE (100) receives the latest handover command to the reporting the RLF report in the handover report transmitted to the base station 1 (200). The base station 2 (300) knows the time since the time when the UE (100) receives the latest handover command to the reporting the RLF report, according to the time since the time when the UE (100) receives the latest handover command to the failure, and the time since the connection failure to the reporting the RLF report, contained in the RLF report. The time since the time when the UE (100) receives the latest handover command to the reporting the RLF report is the time since the time when the UE (100) receives the latest handover command to the failure, plus the time since the failure to the reporting the RLF report. The time since the time when the UE (100) receives the latest handover command to the reporting of the RLF report is included outside of the RLF report container in the handover report message, so that when the base station 1 (200) receives the handover report, the base station knows the time since the time when the UE (100) receives the latest handover command to the reporting of the RLF report, without parsing the RLF report container in RRC format supported by the base station 2 (300).

In one example of Step 307a, if there is no interface between the base station 1 (200) and the base station 2 (300) or the base station 1 (200) and the base station 2 (300) are base stations of different access systems, the base station 2 (300) transmits a handover report to the base station 1 (200) through a core network.

The base station 2 (300) may transmit an uplink configuration transfer message to the mobility management entity 2 (600). The uplink configuration transfer message includes either a handover report or an inter-system handover report.

When the base station 2 (300) and base station 1 (200) support different radio access technologies, for example, the base station 1 (200) may be an NR base station, and the base station 2 (300) may be an E-UTRA base station, for an RLF that occurs after a successful handover from the NR base station to the E-UTRA base station, the RLF report is in an LTE RRC format, and the base station 2 (300) may include the C-RNTI of the UE (100) in the target cell contained in the RLF report in the uplink configuration transfer message, and the C-RNTI of the UE (100) in the target cell is included outside the RLF report container in the uplink configuration transfer message, so that when the base station 1 (200) receives the downlink configuration transfer message, the base station 1 (200) knows the C-RNTI of the UE (100) in the target cell without parsing the RLF report container in the RRC format supported by the base station 2 (300).

The C-RNTI of the UE (100) in the source cell is received from the source base station or received from the UE (100) by a handover request message. If the C-RNTI of the UE (100) in the source cell is received from the UE (100) through the RLF report, the base station 2 (300) includes the C-RNTI of the UE (100) in the source cell contained in the RLF report into the uplink configuration transfer message, and the C-RNTI of the UE (100) in the source cell is included outside the RLF report container in the uplink configuration transfer message, so that when the base station 1 (200) receives the downlink configuration transfer message, the base station 1 (200) knows the C-RNTI of the UE (100) in the source cell without parsing the RLF report container in the RRC format supported by the base station 2 (300).

The base station 2 (300) includes the time since the time when the UE (100) receives the latest handover command to the failure and/or the time since the connection failure to the reporting of the RLF report and/or the time since the failure to the completing the RRC reconnection, and/or the cell identifier of the source cell and/or the cell identifier of the target cell, contained in the RLF report, into the uplink configuration transfer message, the time since the time when the UE (100) receives the latest handover command to the failure and/or the time since the connection failure to the reporting of the RLF report and/or the time since the failure to the completing the RRC reconnection and/or the cell identifier of the source cell and/or the cell identifier of the target cell are included outside the RLF report container in the uplink configuration transfer message, so that when the base station 1 (200) receives the downlink configuration transfer message, the base station knows the time since the time when the UE (100) receives the latest handover command to the failure and/or the time since the connection failure to the reporting of the RLF report and/or the time since the failure to the completing the RRC reconnection and/or the cell identifier of the source cell and/or the cell identifier of the target cell, without parsing the RLF report container in RRC format supported by the base station 2 (300).

The base station 2 (300) may include the time since the time when the UE (100) receives the latest handover command to the reporting the RLF report into the uplink configuration transfer message. The base station 2 (300) knows the time since the time when the UE (100) receives the latest handover command to the reporting the RLF report, according to the time since the time when the UE (100) receives the latest handover command to the failure, and the time since the connection failure to the reporting the RLF report, contained in the RLF report. The time since the time when the UE (100) receives the latest handover command to the reporting the RLF report is the time since the time when the UE (100) receives the latest handover command to the failure, plus the time since the failure to the reporting the RLF report. The time since the time when the UE (100) receives the latest handover command to the reporting of the RLF report is included outside the RLF report container in the uplink configuration transfer message, so that when the base station 1 (200) receives the downlink configuration transfer message, the base station knows the time since the time when the UE (100) receives the latest handover command to the reporting of the RLF report, without parsing the RLF report container in RRC format supported by the base station 2 (300).

The base station 2 (300) may include the C-RNTI of the UE (100) in the source cell, and/or the C-RNTI of the UE (100) in the target cell, and/or the time since the time when the UE (100) receives the latest handover command to the failure, and/or the time since the connection failure to the reporting of the RLF report, and/or the time since the failure to the completing the RLF re-establishment, and/or the time since the time when the UE (100) receives the latest handover command to the reporting the RLF report and/or the cell identifier of the source cell and/or the cell identifier of the target cell, into the handover report or the inter-system handover report in the uplink configuration transfer message.

If the base station 2 (300) is in an enhanced packet system (EPS), the mobility management entity 2 (600) is an MME. The uplink configuration transfer message is an eNB configuration transfer message. The message includes identifier information of the source base station and identifier information of the target base station. The identifier information of the source base station is the identifier information of the base station 2 (300). The identifier information of the target base station is the identifier information of the base station 1 (200). The base station identifier information includes a global cell identifier and a selected tracking area identifier (TAI). If the base station 2 (300) is an eNB, the Identifier information of the source base station includes a global eNB identifier and a selected EPS TAI. The base station 2 (300) knows the global base station identifier and the selected TAI for the base station 1 (200) from identifier information of the previous NR primary cell in the RLF report.

The global base station identifier may be known from the identifier of the previous NR primary cell, and the selected TAI is the selected PLMN identifier and the tracking area code. If the base station 1 (200) is an NR base station, the global base station identifier is a global RAN node identifier. The uplink configuration transfer message includes an identifier of the previous NR primary cell, an identifier of the cell where the failure happens, and an identifier of the suitable cell, a time since the time when the UE (100) receives the latest handover command to the failure, a time since the connection failure to the reporting of the RLF report, a time since the time when the UE (100) receives the latest handover command to the reporting of the RLF report, and/or a time since the failure to completion of RRC reconnection, and/or the RLF report.

The base station 2 (300) may include at least one of the identifier of the NR primary cell, the identifier of the cell where the failure happens, the time since the time when the UE (100) receives the latest handover command to the failure, the time since the connection failure to the reporting of the RLF report, the time since the time when the UE (100) receives the latest handover command to the reporting the RLF report, and/or the time since the failure to the completing the RRC reconnection, and/or the cell identifier of the suitable cell into the uplink configuration transfer message. The identifier of the NR primary cell is the identifier of the previous NR primary cell. The uplink configuration transfer message may also include a too early inter-system handover from the NG-RAN to the E-UTRAN.

It is advantageous for the base station 2 (300) to include the identifier of the NR primary cell, the identifier of the cell where the failure happens, the time since the time when the UE (100) receives the latest handover command to the failure, the time since the connection failure to the reporting of the RLF report, the time since the time when the UE (100) receives the latest handover command to the reporting the RLF report, and/or the time since the failure to the completing the RRC reconnection, and/or the cell identifier of the suitable cell into the uplink configuration transfer message, in that even though the base station 1 (200) cannot parse the RLF report in the RRC format supported by the base station 2 (300), the base station 1 (200) can also know the source NR cell, the target cell, the time since the time when the UE (100) receives the latest handover command to the failure, the time since the connection failure to the reporting of the RLF report, the time since the failure to the completing the RRC reconnection, and/or whether an suitable target cell exists, thereby performing suitable optimization. If the base station 1 (200) receives an identifier of a suitable cell, the base station 1 (200) knows that there is a suitable cell and knows the cell identifier of the suitable cell.

In one example of Step 307b, the mobility management entity 2 (600) may forward the received message to the mobility management entity 1 (500). The mobile management entity 2 (600) locates the mobile management entity 1 (500) based on the selected TAI in the uplink configuration transfer message. If the base station 1 (200) is in a 5G system, then the mobile management entity 1 (500) is an AMF.

In one example of Step 307c, the mobile management entity 1 (500) may transmit a downlink configuration transfer message to the base station 1 (200). The information contained in the downlink configuration transfer message is the same as that in the uplink configuration transfer message in step 307a.

For example, it includes Identifier information of the source base station and Identifier information of the target base station. It may also include the C-RNTI of the UE (100) in the target cell, the C-RNTI of the UE (100) in the source cell, an identifier of the previous NR primary cell, an identifier of the cell where the failure happens, and an identifier of the suitable cell, a time since the time when the UE (100) receives the latest handover command to the failure, a time since the connection failure to the reporting of the RLF report, a time since the time when the UE receives the latest handover command to the reporting of the RLF report, and/or a time since the failure to completion of RRC reconnection, and/or the RLF report.

In this way, based on the received downlink configuration transfer, even though the base station 1 (200) does not parse the RLF report, the base station may also know the identifier of the NR primary cell, the identifier of the cell where the failure happens, the time since the time when the UE (100) receives the latest handover command to the failure, the time since the connection failure to the reporting of the RLF report, the time since the time when the UE (100) receives the latest handover command to the reporting the RLF report, and/or the time since the failure to the completing the RRC reconnection, and/or the cell identifier of the suitable cell, thereby performing optimization accordingly. If the base station 1 (200) receives an identifier of a suitable cell, the base station 1 (200) knows that there is a suitable cell and knows the cell identifier of the suitable cell. If the radio access technologies supported by the base station 1 (200) and the base station 2 (300) are different, the base station 1 (200) may not be able to parse the RLF report encoded by the RRC of the radio access technologies supported by the base station 2 (300).

In this way, based on the information contained in the downlink configuration transfer message, the base station may know the identifier of the NR primary cell, the identifier of the cell where the failure happens, the time since the time when the UE (100) receives the latest handover command to the failure, the time since the connection failure to the reporting of the RLF report, the time since the time when the UE (100) receives the latest handover command to the reporting the RLF report, and/or the time since the failure to the completing the RRC reconnection, and/or the cell identifier of the suitable cell, thereby performing optimization accordingly.

The base station 1 (200) may correlate the successful handover report and the RLF report according to the C-RNTI of the UE (100) in the target cell contained in the successful handover report, the time since the handover command to the reporting of the SHR contained in the successful handover report, the C-RNTI of the UE (100) in the target cell received in the handover report or the downlink configuration transfer message, the time since the time when UE receives the latest handover command to the failure and/or the time since the connection failure to the reporting the RLF report, received in the handover report or the downlink configuration transfer message, thereby knowing that the successful handover report and the RLF report are for the same UE and the same handover.

Alternatively, the base station 1 (200) may correlate the successful handover report and the RLF report based on the C-RNTI of the UE (100) in the target cell contained in the successful handover report, the time since the handover command to the reporting of the SHR, the C-RNTI of the UE (100) in the target cell received in the handover report or the downlink configuration transfer message, and/or the time since the time when UE (100) receives the latest handover command to the reporting of the RLF report, received in the handover report or the downlink configuration transfer message, thereby knowing that the successful handover report and the RLF report are for the same UE and the same handover. The base station 1 (200) also needs to take into account that the target cell contained in the successful handover report and the target cell or the cell where the failure happens contained in the handover report are the same cell. If the target cell contained in the successful handover report and the target cell or the cell where the failure happens contained in the handover report are the same cell, then considering the above factors, it is determined that the successful handover report and the RLF report are for the same event.

The base station 1 (200) may correlate the successful handover report and the RLF report based on the C-RNTI of the UE (100) in the source cell contained in the successful handover report, the time since the handover command to the reporting of the SHR, the C-RNTI of the UE (100) in the source cell received in the handover report or the downlink configuration transfer message, and/or the time since the time when UE (100) receives the latest handover command to the failure time and the time since the connection failure to the reporting the RLF report, received in the handover report or the downlink configuration transfer message, thereby knowing that the successful handover report and the RLF report are for the same UE and the same handover.

Alternatively, the base station 1 (200) may correlate the successful handover report and the RLF report based on the C-RNTI of the UE (100) in the source cell contained in the successful handover report, the time since the handover command to the reporting of the SHR, the C-RNTI of the UE (100) in the source cell received in the handover report or the downlink configuration transfer message, and/or the time since the time when UE (100) receives the latest handover command to the reporting the RLF report, received in the handover report or the downlink configuration transfer message, thereby knowing that the successful handover report and the RLF report are for the same UE and the same handover.

The base station 1 (200) may receive the successful handover report in step 306, and based on the fact that the C-RNTI of the UE (100) in the target cell contained in the successful handover report is the same as the C-RNTI of the UE (100) in the target cell received in step 307 or step 307c, the base station 1 (200) may know that the successful handover report and RLF are correlated and for the same UE, so as to perform proper optimization. The base station 1 (200) may know the C-RNTI of the UE (100) in the target cell from the received handover report message or downlink configuration transfer message, so that it can correlate the successful handover report and the RLF report of the same UE without parsing the RLF report in the RRC format supported by the base station 2 (300), so as to carry out proper optimization.

The base station 1 (200) also needs to take into account that the target cell contained in the successful handover report and the target cell or the cell where the failure happens contained in the handover report are the same cell. If the target cell contained in the successful handover report and the target cell or the cell where the failure happens contained in the handover report are the same cell, then considering the above factors, it is determined that the successful handover report and the RLF report are for the same event.

The base station 1 (200) may receive the successful handover report in step 306, and based on the fact that the C-RNTI of the UE (100) in the source cell contained in the successful handover report is the same as the C-RNTI of the UE (100) in the source cell received in step 307 or step 307c, the base station 1 (200) may know that the successful handover report and RLF are correlated and for the same UE, so as to perform proper optimization. The base station 1 (200) knows the C-RNTI of the UE (100) in the source cell from the received handover report message or downlink configuration transfer message, so that it can correlate the successful handover report and the RLF report of the same UE without parsing the RLF report in the RRC format supported by the base station 2 (300), so as to carry out proper optimization.

The base station 1 (200) receives the successful handover report in step 306, and based on the fact that the C-RNTI of the UE (100) in the source cell contained in the successful handover report is the same as the C-RNTI of the UE (100) in the source cell received in step 307 or step 307c, and according to the time since the handover command to the reporting the SHR contained in the successful handover report, or the time since the handover command to the failure and the time since the connection failure to the reporting the RLF report received in step 307 or step 307c, or the handover command to the reporting the RLF report received in step 307 or step 307c, the base station 1 (200) knows that the successful handover report and the RLF report are correlated and for the same UE and the same handover, thereby performing suitable optimization. The base station 1 (200) knows the time since the handover command to the reporting of the RLF according to the time since the handover command to the failure and the time since the connection failure to the reporting of the RLF report, received in step 307 or step 307c.

Alternatively, the base station 1 (200) receives the time since the handover command to the reporting of the RLF directly in step 307 or step 307c. The base station 1 (200) knows the time when the handover corresponding to the RLF report occurs according to the time since the handover command to the reporting of the RLF. The base station 1 (200) knows the time when the handover corresponding to the SHR occurs according to the time since the handover command to the reporting of the SHR. Based on the fact that the time when the handover corresponding to the RLF report occurs is the same as the time when the handover corresponding to the SHR occurs, and that the C-RNTI of the UE (100) in the source cell contained in the successful handover report is the same as the C-RNTI of the UE (100) in the source cell received in step 307 or step 307c, the base station 1 (200) knows that the RLF report and SHR are correlated. The base station 1 (200) knows, from the received handover report message or downlink configuration transfer message, the C-RNTI of the UE (100) in the source cell, the time since the handover command to the failure and/or the time since the connection failure to the reporting the RLF report and/or the time since the handover command to the reporting the RLF report, so that it can correlate the successful handover report and the RLF report of the same UE without parsing the RLF report in the RRC format supported by the base station 2 (300), so as to carry out proper optimization.

The base station 1 (300) may receive the successful handover report in step 306, and based on the fact that the C-RNTI of the UE (100) in the target cell contained in the successful handover report is the same as the C-RNTI of the UE in the target cell received in step 307 or step 307c, and according to the time since the handover command to the reporting the SHR contained in the successful handover report, and the time since the handover command to the failure and the time since the connection failure to the reporting the RLF report received in step 307 or step 307c, or the time since the handover command to the reporting the RLF report received in step 307 or step 307c, the base station 1 (200) may know that the successful handover report and the RLF report are correlated, and for the same UE and the same handover, thereby performing suitable optimization. The base station 1 (200) may know the time since the handover command to the reporting of the RLF according to the time since the handover command to the failure and the time since the connection failure to the reporting of the RLF report, received in step 307 or step 307c.

Alternatively, the base station 1 (200) may receive the time since the handover command to the reporting of the RLF directly in step 307 or step 307c. The base station 1 (200) may know the time when the handover corresponding to the RLF report occurs according to the time since the handover command to the reporting of the RLF. The base station 1 (200) may know the time when the handover corresponding to the SHR occurs according to the time since the handover command to the reporting of the SHR. Based on the fact that the time when the handover corresponding to the RLF report occurs is the same as the time when the handover corresponding to the SHR occurs, and that the C-RNTI of the UE (100) in the target cell contained in the successful handover report is the same as the C-RNTI of the UE (100) in the target cell received in step 307 or step 307c, the base station 1 (200) knows that the RLF report and SHR are correlated.

The base station 1 (200) may know the C-RNTI of the UE (100) in the target cell, the time since the handover command to the failure, and/or the time since the connection failure to the reporting the RLF report, and/or the time since the handover command to the reporting the RLF report from the received handover report message or downlink configuration transfer message, so that it can correlate the successful handover report and the RLF report of the same UE without parsing the RLF report in the RRC format supported by the base station 2 (300), so as to carry out proper optimization. The base station 1 (200) also needs to take into account the case where the target cell contained in the successful handover report and the target cell or the cell where the failure happens contained in the handover report are the same cell. If the target cell contained in the successful handover report and the target cell or the cell where the failure happens contained in the handover report are the same cell, then considering the above factors, it is determined that the successful handover report and the RLF report are for the same event.

The base station 1 (200) may receive the successful handover report in step 306, and based on the fact that the C-RNTI of the UE (100) in the source cell contained in the successful handover report is the same as the C-RNTI of the UE (100) in the source cell received in step 307 or step 307c, and according to the time since the handover command to the reporting the SHR contained in the successful handover report, and the time since the handover command to the failure received in step 307 or step 307c, the base station 1 (200) may know that the successful handover report and the RLF report are correlated and for the same UE and the same handover, thereby performing suitable optimization. The base station 1 (200) may know, from the received handover report message or downlink configuration transfer message, the C-RNTI of the UE (100) in the source cell and the time since the handover command to the failure, so that it can correlate the successful handover report and the RLF report of the same UE without parsing the RLF report in the RRC format supported by the base station 2 (300), so as to carry out proper optimization.

The base station 1 (200) may receive the successful handover report in step 306, and based on the fact that the C-RNTI of the UE (100) in the source cell contained in the successful handover report is the same as the C-RNTI of the UE (100) in the source cell received in step 307 or step 307c, and according to the time since the handover command to the reporting the SHR contained in the successful handover report, and the time since the connection failure to the reporting the RLF report received in step 307 or step 307c, the base station 1 (200) may know that the successful handover report and the RLF report are correlated and for the same UE and the same handover, thereby performing suitable optimization. The base station 1 (200) may know the C-RNTI of the UE (100) in the source cell from the received handover report message or downlink configuration transfer message, and the time since the connection failure to the reporting of the RLF report, so that the base station 1 (200) can correlate the successful handover report and the RLF report of the same UE without parsing the RLF report in the RRC format supported by the base station 2 (300), so as to carry out proper optimization.

The method 1 supporting self-configuration and self-optimization in accordance with the present disclosure is now completed. By this method, in case of a potential handover failure or a handover failure or a failure after a successful handover, causes for such potential failure or failure may be correctly identified and proper optimization may be carried out accordingly, thereby reducing failures, ensuring service continuity, and reducing the labour cost of the operator. Furthermore, in case that both a potential failure in a successful handover and a failure occur, a network end may correlate such potential failure and the failure for a same UE and perform proper optimization, thereby reducing failures, ensuring service continuity, and reducing the labour cost of the operator.

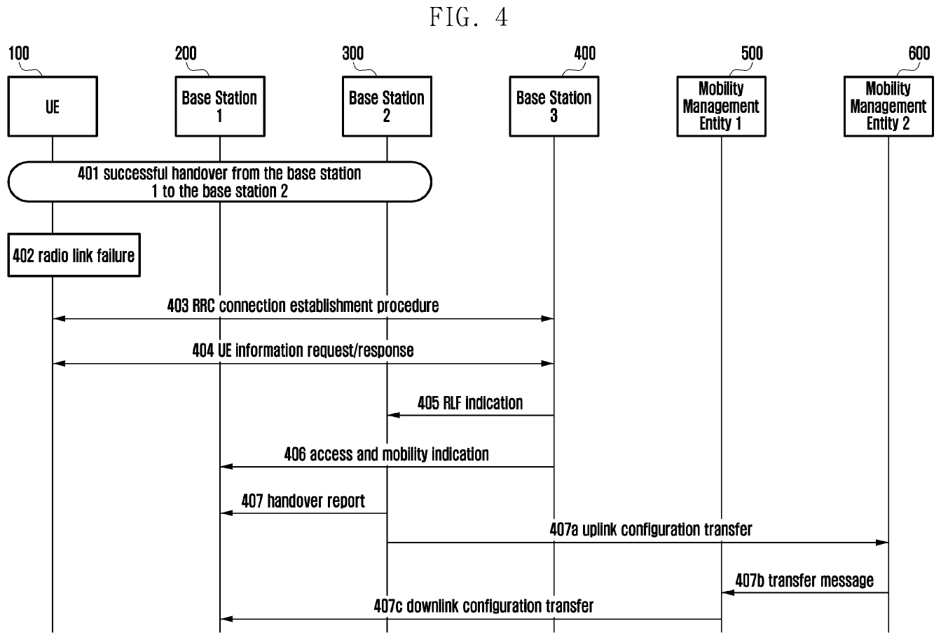

An example of a second method supporting self-configuration and self-optimization in accordance with the present disclosure is shown in FIG. 4. The method includes the following steps:

Step 401: A base station 1 (200) hands over UE (100) to a base station 2 (300). The base station 1 (200) and the base station 2 (300) are base stations that support the same radio access technologies, base stations that support different radio access technologies or base stations for different systems. For example, the base station 1 (200) is a base station that supports the NR, and the base station 2 (300) is an LTE base station or an E-UTRAN base station or an LTE base station connected to a 5G core network, or an NR base station. The handover process is completed successfully.

The condition for triggering a successful handover report is met, and the UE (100) stores the successful handover report (SHR). The successful handover report includes a cell radio network temporary identifier (C-RNTI) assigned by a target cell to the UE (100) and/or a C-RNTI assigned by a source cell to the UE (100). The successful handover report includes a time since the handover command to the reporting of the successful handover report. The time since the handover command to the reporting of the successful handover report may also referred as a time since the time when the latest RRC connection reconfiguration message containing a mobility control information is received to the successful handover report retrieval or a time since the handover command to the UE information request message requesting the SHR. The handover command is the latest handover command. The successful handover report comprises information of the source cell and information of the target cell. The information of the source cell comprises global cell identifier information of the source cell. The information of the target cell comprises global cell identifier information of the target cell. The global cell identifier information comprises a global cell identifier and a tracking area code.

In one example of Step 402, the UE (100) may encounter radio link failure (RLF) in a cell of the base station 2 (300).

The UE (100) stores the radio link failure information. The UE stores the radio link failure information in an RLF report variable. The information contained in the radio link failure information are the same as that in step 302, which will not be further described herein.

In one example of Step 403, the UE initiates an RRC reestablishment procedure at a base station 3. The UE transmits an RRC connection reestablishment request message to the base station 3. The base station 3 transmits an RRC connection reestablishment message to the UE. The UE transmits an RRC connection reestablishment complete message to the base station 3.

If the UE has a successful handover report stored, the RRC connection reestablishment complete message includes successful handover report information available. If there is successful handover information in the successful handover report variable and a registered PLMN is included in a list of PLMN identifiers stored in the successful handover report variable, the UE includes successful handover information available in the RRC connection reestablishment complete message.

In one example of Step 404, the base station 3 transmits a UE information request message to the UE. The base station 3 transmits the UE information request message to the UE after receiving the information that the successful handover information is available.

The UE transmits a UE information request response message to the base station 3. The UE information response message includes the successful handover report. The successful handover report includes the same information as described in step 401, which will not be further described herein.

For the failure of the handover from an NR base station to an E-UTRA base station, the base station 3 may be the NR base station or the E-UTRA base station.

In one example of Step 405, the base station 3 transmits an RLF indication message to the base station of the cell where the failure happens. Here, the base station of the cell where the failure happens is the base station 2. The RLF indication message includes a cell identifier of the cell where the failure happens. The cell identifier of the cell where the failure happens may be a physical cell identifier. The RLF indication message includes a C-RNTI. The C-RNTI is received from the RRC reestablishment request message. The C-RNTI is the C-RNTI of the UE in the target cell of the base station 2. The C-RNTI is the C-RNTI of the UE in the cell where the failure happens.

The base station 3 (400) may transmit the RLF indication message to the base station 2 (300) through an inter-base station interface, or transmits the RLF indication information to the base station 2 (300) through a core network. The RLF indication information transmitted through the core network includes the same content as that included in the RLF indication message transmitted through the inter-base station interface.

The base station 2 (300) may detect a cause for the failure.

The base station 2 (300) transmits a handover report to a source base station, where the source base station is the base station 1 (200).

The message transmitted by the base station 2 (300) to the base station 1 (200), or the message transmitted by the base station 2 (300) to the core network includes the C-RNTI of the UE (100) in the target cell, the time that the UE (100) stayed in the target cell, and/or the C-RNTI of the UE (100) in the source cell. The time that the UE (100) stayed in the target cell is the time from the UE (100) accessing to the target cell to occurrence of the failure, the time from the UE (100) accessing to the target cell to reception of the RLF indication by the target base station, the time from the UE (100) accessing to the target cell to reception of the RRC reestablishment request from the UE (100) by the target base station, or the time from the UE (100) accessing to the target cell to reception of the RRC reestablishment completion from the UE (100) by the target base station. The base station 2 (300) can also obtain the time that the UE (100) stayed in the target cell according to the UE history information. The message may further include the UE history information, through which the base station 1 knows the time that the UE (100) stayed in the target cell.

In one example of Step 406, if the base station 3 (400) receives a successful handover report and the cause for the successful handover report is T310 and/or T312, the base station 3 (400) transmits the successful handover report received to source base station of the corresponding handover, where the source base station of the corresponding handover is the base station 1 (200). The base station 3 (400) may transmit a received successful handover report to the base station 1 (200) by an access and mobility indication messages or another message.

If the base station 3 (400) receives a successful handover report and the cause for the successful handover report is T304, the base station 3 (400) transmits the successful handover report received to the corresponding target base station for the handover, where the target base station for the handover is the base station 2 (300). The base station 3 (400) may transmit a received successful handover report to the base station 2 (300) by an access and mobility indication messages or another message.

The base station 3 (400) may also include the C-RNTI of the UE (100) in the source cell, the C-RNTI of the UE in the target cell, and/or the time since the handover command to the reporting of the SHR contained in the successful handover report into a message transmitted to the base station 2 (300) or the base station 1 (200), so that even if the base station 2 (300) or the base station 1 (200) does not parse the successful handover report, the base station may also know the C-RNTI of the UE (100) in the source cell, the C-RNTI of the UE (100) in the target cell, and/or the time since the handover command to the reporting of the SHR, so as to correlate the successful handover report and the RLF. The base station 3 (400) may also include another information element in the successful handover report in the message transmitted to the base station 2 (300) or the base station 1 (200), so that even if the base station 2 (300) or the base station 1 (200) does not parse the successful handover report, the corresponding information can be obtained.

To correlate the successful handover report and the RLF described in the present disclosure refers to confirming that the successful handover report and the RLF are for the same UE, or confirming that the successful handover report and the RLF are for the same UE the same handover, or confirming that the successful handover report and the RLF are for the same event. If the successful handover report and the RLF report are for the same event, then the successful handover report can be ignored and only the RLF is considered.

In the present disclosure, the successful handover report and the RLF described being correlated indicates that the successful handover report and the RLF are for the same UE, or that the successful handover report and the RLF are for the same UE the same handover, or that the successful handover report and the RLF are for the same event.

The base station 2 (300) receives the successful handover report and the RLF indication, and the base station 2 (300) correlates the successful handover report and the RLF if the C-RNTI of the UE (100) in the target cell contained in the successful handover report and the C-RNTI of the UE (100) in the target cell in the RLF indication are the same. Alternatively, the base station 2 (300) correlates the successful handover report and the RLF if the C-RNTI of the UE (100) in the target cell contained in the message containing the successful handover report and the C-RNTI contained in the RLF indication are the same.

Alternatively, the base station 2 (300) correlates the successful handover report and the RLF according to the C-RNTI of the UE (100) in the target cell included in the successful handover report, the time from the handover command to reporting of the SHR included in the successful handover report, the C-RNTI included in the RLF indication, and/or the time that the UE (100) stayed in the target cell, thereby knowing that the successful handover report and the RLF are for the same UE and the same handover. During determination of correlation described above, the base station 2 (300) also needs to take into account that the target cell included in the successful handover report and the cell where the RLF failure happens are the same cell. The base station 2 (300) knows the cell where the RLF failure happens according to the cell identifier of the cell where the failure happens included in the received RLF indication message. If the target cell included in the successful handover report and the cell where the RLF failure happens are the same cell, then considering the above factors, it is determined that the successful handover report and the RLF are for the same event.

According to the fact that the C-RNTI of the UE (100) in the target cell contained in the successful handover report is the same as the C-RNTI received in step 405, and according to the time from the handover command to the reporting of the SHR contained in the successful handover report and the time that the UE (100) stayed in the target cell, the base station 2 knows that the successful handover report and the RLF are correlated, and for the same UE and the same handover, thereby performing proper optimization. The time that the UE (100) stayed in the target cell is the same as that described above, and will not be further described herein. The base station 2 (300) knows the time when the handover corresponding to the RLF occurs according to the time that the UE (100) stayed in the target cell, and the base station 2 (300) knows the time when the handover corresponding to the SHR occurs according to the time from the handover command to the reporting of the SHR.

According to the fact that the time when the handover corresponding to the RLF occurs is the same as the time when the handover corresponding to the SHR occurs, and that the C-RNTI of the UE (100) in the target cell contained in the successful handover report is the same as the C-RNTI received in step 405, the base station 2 (300) knows that the RLF and the SHR are correlated, thereby performing proper optimization. During determination of correlation described above, the base station 2 (300) also needs to take into account the case where the target cell contained in the successful handover report and the cell where the RLF failure happens are the same cell. The base station 2 (300) knows the cell where the RLF failure happens according to the cell identifier of the cell where the failure happens contained in the received RLF indication message. If the target cell contained in the successful handover report and the cell where the RLF failure happens are the same cell, then considering the above factors, it is determined that the successful handover report and the RLF are for the same event.

For successful handover report caused by the T304 threshold, correlation is made by the target base station. For successful handover report caused by the T310 threshold and/or the T312 threshold, the correlation is performed by the source base station, which is specifically described in step 407 or step 407c.

In one example of Step 407, the base station 2 (300) transmits a handover report to the base station 1 (200). For an intra-system handover, if the base station 2 (300) and the base station 1 (200) have interfaces, then the base station 2 (300) transmits the handover report to the base station 1 (200) through an inter-base station interface. The handover report includes the C-RNTI of the UE in the source cell and/or the C-RNTI of the UE (100) in the target cell. The handover report includes the time that the UE (100) stayed in the target cell. The time that the UE (100) stayed in the target cell is the same as that described above, and will not be further described herein. The message may further comprise the UE (100) history information, through which the base station 1 knows the time that the UE (100) stayed in the target cell.

In one example of Step 407a, if there is no interface between the base station 1 and the base station 2 (300) or the base station 1 (200) and the base station 2 (300) are base stations of different access systems, then the base station 2 (300) transmits the handover report to the base station 1 (200) through the core network.

The base station 2 (300) transmits an uplink configuration transfer message to the mobility management entity 2 (600). The uplink configuration transfer message includes a handover report or an inter-system handover report.

The base station 2 (300) may include the C-RNTI of the UE (100) in the source cell, and/or the C-RNTI of the UE (100) in the target cell, and/or the time that the UE (100) stayed in the target cell, and/or the UE history information into the handover report or the inter-system handover report in the uplink configuration transfer message.

If the base station 2 (300) is in an enhanced packet system (EPS), then the mobility management entity 2 (600) is an MME. The uplink configuration transfer message is an eNB configuration transfer message. The message includes identifier information of the source base station and identifier information of the target base station. The identifier information of the source base station is the identifier information of the base station 2 (300). The identifier information of the target base station is the identifier information of the base station 1 (200). The identifier information of the base stations includes a global cell identifier and a selected tracking area identifier (TAI).

If the base station 2 (300) is an eNB, then the identifier information of the source base station includes a global eNB identifier and a selected EPS TAI. If the base station 1 (200) is an NR base station, then the global base station identifier is a global RAN node identifier. The uplink configuration transfer message includes an identifier of a previous NR primary cell, a cell identifier of a cell where the failure happens, and/or a cell identifier of a suitable cell. The identifier of the NR primary cell is the identifier of the previous NR primary cell. The uplink configuration transfer message may also comprise a too early inter-system handover from the NG-RAN to the E-UTRAN. If the base station 1 (200) receives a cell identifier of a suitable cell, then the base station 1 (200) knows that there is the suitable cell and knows the cell identifier of the suitable cell.

In one example of Step 407b, the mobility management entity 2 (600) forwards the received message to the mobility management entity 1 (500). The mobility management entity 2 (600) locates the mobility management entity 1 (500) based on the selected TAI in the uplink configuration transfer message. If the base station 1 (200) is in a 5G system, then the mobility management entity 1 (500) is an AMF.

In one example of Step 407c, the mobility management entity 1 (500) transmits a downlink configuration transfer message to the base station 1 (200). The downlink configuration transfer message includes the same information as that in the uplink configuration transfer message in step 407a.

For example, the downlink configuration transfer message includes identifier information of the source base station and identifier information of the target base station. The downlink configuration transfer message also includes the C-RNTI of the UE (100) in the target cell, the C-RNTI of the UE (100) in the source cell, an identifier of a previous NR primary cell, a cell identifier of a cell where the failure happens, a cell identifier of a suitable cell, the time that the UE (100) stayed in the target cell, and/or the UE history information. If the base station 1 (200) receives a cell identifier of a suitable cell, then the base station 1 (200) knows that there is a suitable cell and knows the cell identifier of the suitable cell.

The base station 1 (200) correlates the successful handover report and the RLF according to the C-RNTI of the UE (100) in the target cell contained in the successful handover report, the time from the handover command to reporting of the SHR contained in the successful handover report, the C-RNTI received from the handover report or the downlink configuration transfer message, and/or the time that the UE (100) stayed in the target cell received from the handover report or the downlink configuration transfer message, thereby knowing that the successful handover report and the RLF are for the same UE and the same handover. The base station 1 (200) also needs to take into account that the target cell contained in the successful handover report and the cell where the RLF failure happens are the same cell. The base station 1 (200) knows the cell where the RLF failure happens according to the cell identifier of the cell where the failure happens contained in the received handover report. If the target cell contained in the successful handover report and the cell where the RLF failure happens are the same cell, then considering the above factors, it is determined that the successful handover report and the RLF are for the same event.

The base station 1 (200) receives the successful handover report in step 406, and according to the fact that the C-RNTI of the UE (100) in the target cell contained in the successful handover report is the same as the C-RNTI received in step 407 or step 407c, the base station 1 (200) knows that the successful handover report and the RLF are correlated, and for the same UE, thereby performing proper optimization. The base station 1 (200) also needs to take into account that the target cell contained in the successful handover report and the cell where the RLF failure happens are the same cell. The base station 1 (200) knows the cell where the RLF failure happens according to the cell identifier of the cell where the failure happens contained in the received handover report. If the target cell contained in the successful handover report and the cell where the RLF failure happens are the same cell, then considering the above factors, it is determined that the successful handover report and the RLF are for the same event.

The base station 1 (200) receives the successful handover report in step 406, and according to the fact that the C-RNTI of the UE (100) in the target cell contained in the successful handover report is the same as the C-RNTI received in step 407 or step 407c, and according to the time from the handover command to reporting of the SHR contained in the successful handover report and the time that the UE stayed in the target cell received in step 407 or step 407c, the base station 1 (200) knows that the successful handover report and the RLF are correlated, and for the same UE and the same handover, thereby performing suitable optimization.

The base station 1 (200) knows the time when the handover corresponding to the RLF occurs according to the time that the UE (100) stayed in the target cell, and the base station 1 (200) knows the time when the handover corresponding to the SHR occurs according to the time from the handover command to reporting of the SHR. According to the fact that the time when the handover corresponding to the RLF occurs is the same as the time when the handover corresponding to the SHR occurs, and that the C-RNTI of the UE (100) in the target cell contained in the successful handover report is the same as the C-RNTI received in step 407 or step 407c, the base station 1 (200) knows that the RLF and the SHR are correlated. The C-RNTI received by the base station 1 (200) from the handover report message or the downlink configuration transfer message is the C-RNTI of the UE (100) in the target cell. The C-RNTI received by the base station 1 (200) from the handover report message or the downlink configuration transfer message is the C-RNTI of the UE (100) in the cell where the failure happens.

The base station 1 also needs to consider that the target cell contained in the successful handover report and the cell where the RLF failure happens are the same cell. The base station 1 (200) knows the cell where the RLF failure happens according to the cell identifier of the cell where the failure happens contained in the received handover report. If the target cell contained in the successful handover report and the cell where the RLF failure happens are the same cell, then considering the above factors, it is determined that the successful handover report and the RLF are for the same event.

The second method supporting self-configuration and self-optimization in accordance with the present disclosure is now completed. By this method, in case of a potential handover failure or a handover failure or a failure after a successful handover, causes for such potential failure or failure may be correctly identified and proper optimization may be carried out accordingly, thereby reducing failures, ensuring service continuity, and reducing the labour cost of the operator. Furthermore, in case that both a potential failure in a successful handover and a failure occur, a network end may correlate such potential failure and the failure for a same UE and perform proper optimization, thereby reducing failures, ensuring service continuity, and reducing the labour cost of the operator.

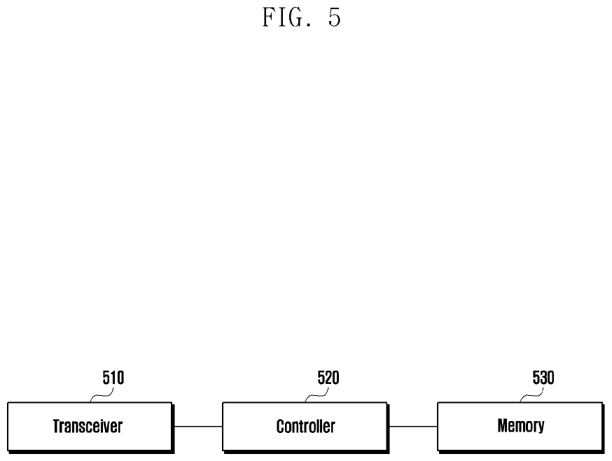

FIG. 5 illustrates a network node in accordance with the present disclosure.

The network node in the network may be used to implement a UE, a first base station, a second base station, a third base station, a mobile management entity 1, a mobile management entity 2, and the like, in the present disclosure. Referring to FIG. 5, a network node in accordance with the present disclosure includes a transceiver 510, a controller 520, and a memory 530. The transceiver 510, the controller 520 and the memory 530 are configured to perform operations and/or embodiments of the present disclosure. Although the transceiver 510, the controller 520 and the memory 530 are shown as separate entities, they may be embodied as a single entity, such as a single chip. The transceiver 510, the controller 520, and the memory 530 may be electrically connected or coupled with each other. The transceiver 510 may transmit and receive signals to and from another network entity, where the other network entity may be for example a UE, an MN, an SN, an S-SN, a T-SN, or another- or candidate T-SN or core network node The controller 520 may include one or more processing units, and may control the network node to perform operations and/or functions of one of the foregoing embodiments. The memory 530 may store instructions for implementing operations and/or functions of one of the foregoing embodiments.

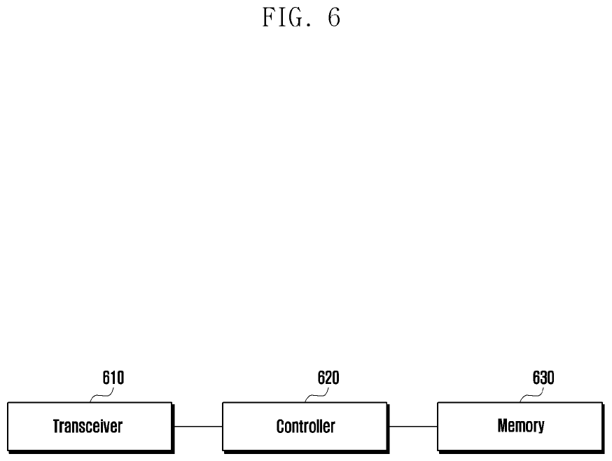

FIG. 6 illustrates a UE in accordance with the present disclosure. Referring to FIG. 6, a user equipment in accordance with the present disclosure includes a transceiver 610, a controller 620, and a memory 630. The transceiver 610, the controller 620 and the memory 630 are configured to perform operations and/or embodiments of the present disclosure. Although the transceiver 610, the controller 620 and the memory 630 are shown as separate entities, they may be embodied as a single entity, such as a single chip. The transceiver 610, the controller 620, and the memory 630 may be electrically connected or coupled with each other. The transceiver 610 may transmit and receive signals to and from another network entity, where the other network entity may be for example a UE, an MN, an SN, an S-SN, a T-SN, or another- or candidate T-SN or core network node The controller 620 may include one or more processing units, and may control the UE to perform operations and/or functions of one of the foregoing embodiments. The memory 630 may store instructions for implementing operations and/or functions of one of the foregoing embodiments.

According to one aspect of the present disclosure, a method performed by a user equipment (UE) in a wireless communication system is provided. The method may include saving, by the UE, a successful handover report, where the successful handover report includes a C-RNTI of the UE in a source cell; encountering, by the UE, a radio link failure RLF; saving, by the UE, radio link failure information; transmitting, by the UE, a UE information request response message to a third base station, where the UE information request response message includes an RLF report; transmitting, by the UE, the UE information request response message to a fourth base station, where the UE information request response message includes the successful handover report, where the successful handover report includes the C-RNTI of the UE in the source cell.

Optionally, the UE may transmit the RLF report and the successful handover report to a same base station through the UE information request response message. In other words, the fourth base station and the third base station are the same base station.

Optionally, the radio link failure information or the radio link failure report includes the C-RNTI of the UE in the source cell.

Optionally, the successful handover report includes a C-RNTI of the UE in a target cell.

A method performed by a third base station in a wireless communication system includes:
receiving an information request response message from a UE, where the UE information request response message includes a successful handover report, where the successful handover report includes at least one of: a C-RNTI of the UE in a source cell; a C-RNTI of the UE in a target cell; a time since a latest handover command to the reporting of the successful handover report.

If the successful handover report is caused by configuration of the source base station, the third base station transmits the received successful handover report to the first base station that triggers the handover, and if the successful handover report is caused by configuration of the target base station, the third base station transmits the received successful handover report to the second base station, which is the target base station of the handover.

A method performed by a second base station in a wireless communication system includes:
receiving a message including an RLF report, where the RLF report includes at least one of: a C-RNTI of a UE in a source cell; a C-RNTI of a UE in a target cell; detecting a cause for the failure.

The second base station transmits a handover report to the first base station, where the handover report includes at least one of: the C-RNTI of the UE in the source cell; the C-RNTI of the UE in the target cell; a time since the time when the UE receives the latest handover command to the failure; a time since the connection failure to the reporting of the RLF report; a time since the time when the UE receives the latest handover command to the RLF report retrieval; and a time since the failure to completion of RRC reconnection.

Optionally, the C-RNTI of the UE in the source cell, and/or the C-RNTI of the UE in the target cell, and/or the time since the time when the UE receives the latest handover command to the failure, and/or the time since the connection failure to the reporting of the RLF report, and/or the time since the time when the UE receives the latest handover command to the RLF report retrieval, and/or the time since the failure to the completion of RRC reconnection are included outside an RLF report container in the handover report.

Optionally, the second base station transmits the handover report to the first base station through an inter-base station interface or through a core network.

Optionally, the second base station receives a message including a successful handover report, where the successful handover report includes at least one of: the C-RNTI of the UE in the source cell; the C-RNTI of a UE in the target cell; the time since the latest handover command to the successful handover report retrieval.

Optionally, the second base station knows that the RLF report and the successful handover report are correlated based on the C-RNTI of the UE in the target cell in the received RLF report and the C-RNTI of the UE in the target cell in the successful handover report.

Optionally, the second base station knows that the RLF report and the successful handover report are correlated based on the C-RNTI of the UE in the source cell in the received RLF report and the C-RNTI of the UE in the source cell in the successful handover report.

Optionally, the second base station correlates the successful handover report and the RLF report based on the C-RNTI of the UE in the target cell contained in the successful handover report, the time since the handover command to the reporting of the SHR, the C-RNTI of the UE in the target cell, and/or the time since the time when UE receives the latest handover command to the failure and the time since the connection failure to the RLF report retrieval contained in the RLF report.

Optionally, the second base station correlates the successful handover report and the RLF report based on the C-RNTI of the UE in the source cell contained in the successful handover report, the time since the handover command to the reporting of the SHR, the C-RNTI of the UE in the source cell contained in the RLF report, and/or the time since the time when UE receives the latest handover command to the failure and the time since the connection failure to the RLF report retrieval contained in the RLF report.

A method performed by a first base station in a wireless communication system includes:
receiving a message including a successful handover report, where the successful handover report includes at least one of: a C-RNTI of a UE in a source cell; a C-RNTI of a UE in a target cell; a time since the latest handover command to the successful handover report retrieval;
receiving a handover report, where the handover report includes at least one of: the C-RNTI of the UE in the source cell; the C-RNTI of the UE in the target cell; a time since the time when the UE receives the latest handover command to the failure; a time since the connection failure to the reporting of the RLF report; the RLF report; a time since the time when the UE receives the latest handover command to the RLF report retrieval; and a time since the failure to completion of RRC reconnection;

Optionally, the received RLF report and the successful handover report are correlated.

Optionally, it is known that the RLF report and the successful handover report are correlated based on the C-RNTI of the UE in the target cell in the received successful handover report and the C-RNTI of the UE in the target cell in the handover report.

Optionally, it is known that the RLF report and the successful handover report are correlated based on the C-RNTI of the UE in the source cell in the received successful handover report and the C-RNTI of the UE in the source cell in the handover report.

Optionally, it is known that the RLF report and the successful handover report are correlated based on the C-RNTI of the UE in the source cell in the received successful handover report, the C-RNTI of the UE in the source cell in the handover report, the time since the handover command to the failure and the time since the connection failure to the RLF report retrieval.

Optionally, it is known that the RLF report and the successful handover report are correlated based on the C-RNTI of the UE in the source cell in the received successful handover report and the C-RNTI of the UE in the source cell in the handover report, the time since the handover command to the reporting SHR and the time since the handover command to the failure.

Optionally, it is known that the RLF report and the successful handover report are correlated based on the C-RNTI of the UE in the source cell in the received successful handover report and the C-RNTI of the UE in the source cell in the handover report, the time since the handover command to the reporting SHR and the time since the connection failure to the RLF report retrieval.

Optionally, the successful handover report and the RLF report are correlated based on the C-RNTI of the UE in the target cell contained in the successful handover report, the time since the handover command to the reporting of the SHR, the C-RNTI of the UE in the target cell received in the handover report or the downlink configuration transfer message, and/or the time since the time when UE receives the latest handover command to the failure time and the time since the connection failure to the RLF report retrieval, received in the handover report or the downlink configuration transfer message.

Optionally, the successful handover report and the RLF report are correlated based on the C-RNTI of the UE in the target cell contained in the successful handover report, the time since the handover command to the reporting of the SHR, the C-RNTI of the UE in the target cell received in the handover report or the downlink configuration transfer message, and/or the time since the time when UE receives the latest handover command to the RLF report retrieval.

Optionally, the successful handover report and the RLF report are correlated based on the C-RNTI of the UE in the source cell contained in the successful handover report, the time since the handover command to the reporting of the SHR, the C-RNTI of the UE in the source cell received in the handover report or the downlink configuration transfer message, and/or the time since the time when UE receives the latest handover command to the failure time and the time since the connection failure to the RLF report retrieval, received in the handover report or the downlink configuration transfer message.

Optionally, the successful handover report and the RLF report are correlated based on the C-RNTI of the UE in the source cell contained in the successful handover report, the time since the handover command to the reporting of the SHR, the C-RNTI of the UE in the source cell received in the handover report or the downlink configuration transfer message, and/or the time since the time when UE receives the latest handover command to the RLF report retrieval.

A UE includes: a transceiver and a controller, where the controller is configured to perform the methods performed by the UE as described above.

A third base station includes: a transceiver and a controller, where the controller is configured to perform the methods performed by the third base station as described above.

A second base station includes: a transceiver and a controller, where the controller is configured to perform the methods performed by the second base station as described above.

It may be appreciated by those skilled in the art that the above illustrative embodiments are described herein and are not intended to be restrictive. It should be understood that any two or more embodiments disclosed herein may be combined in any combination. In addition, other embodiments may be utilized and other changes may be made without departing from the spirit and scope of the subject presented herein. It may be easily understood that, as generally described herein and shown in the drawings, various aspects of the present disclosure may be arranged, replaced, combined, separated and designed in various configurations, all of which are envisaged herein.

It may be appreciated by those skilled in the art that the various illustrative logic boxes, modules, circuits, and steps described in the present application may be implemented as hardware, software, or a combination thereof. In order to clearly illustrate this interchangeability of hardware and software, various illustrative components, boxes, modules, circuits, and steps are generally described above in the form of their feature sets. Whether such a feature set is implemented as hardware or software depends on the specific application and the design constraints imposed on the overall system. Those skilled in the art may implement the described feature sets in a different way for each particular application, but such design decisions should not be interpreted as causing them to depart from the scope of the present application.

The various illustrative logic boxes, modules, and circuits described in this application may be embedded or executed by a general-purpose processor, a digital signal processor (DSP), an application-specific integrated circuit (ASIC), a field programmable gate array (FPGA) or another programmable logic device, a discrete gate or a transistor logic, a discrete hardware component, or any combination thereof designed to perform the functions described herein. A general-purpose processor may be a microprocessor, but in an alternative scenario, the processor may be any conventional processor, controller, microcontroller, or state machine. The processor may also be implemented as a combination of computing devices, such as a combination of a DSP and a microprocessor, a plurality of microprocessors, one or more microprocessors working with the DSP core, or any other such configurations.

The steps of the method or algorithm described in the present application may be embodied directly in hardware, in a software module executed by the processor, or a combination thereof. The software module may reside in an RAM memory, a flash memory, an ROM memory, an EPROM memory, an EEPROM memory, a register, a hard disk, a removable disk, or any other forms of storage media known in the art. An exemplary storage medium is coupled to a processor so that the processor can read and write information from/to the storage medium. Alternatively, the storage medium may be integrated into the processor. The processor and storage medium may reside in an ASIC. The ASIC may reside in a user terminal. Alternatively, the processor and storage medium may reside in a user terminal as discrete components.

In one or more exemplary designs, the functions may be embodied in hardware, software, firmware, or any combination thereof. If implemented in software, the functions may be stored as one or more instructions or codes on a computer-readable medium or transmitted thereby. The computer-readable medium includes both a computer storage medium and a communication medium, and the latter includes any medium that facilitates the transfer of a computer program from one place to another place. The storage medium may be any available medium that can be accessed by a general-purpose or specialized computer.

The foregoing shows only exemplary embodiments of the present application and is not intended to limit the scope of protection of the present application, which is determined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
storing a successful handover report including information on a cell radio network temporary identifier (C-RNTI) assigned by a target cell for a handover in case that the handover is completed;
identifying that a radio link failure (RLF) is detected;
storing radio link failure information based on the RLF, the radio link failure information including the C-RNTI assigned by the target cell;
receiving, from a base station, a user equipment (UE) information request message; and
transmitting, to the base station, a UE information response message including at least one of the successful handover report or the radio link failure information in response to receiving the UE information request message.

2. The method of claim 1, wherein the handover is performed from a source cell associated with a new radio (NR) to a target cell associated with an evolved universal terrestrial radio access (E-UTRA),
wherein the successful handover report further includes at least one of first information indicating a time elapsed since an execution of a handover command, second information of the source cell, or third information of the target cell,
wherein the second information of the source cell comprises a global cell identity and a tracking area code of the source cell, and
wherein the third information of the target cell comprises a global cell identity and a tracking area code of the target cell.

3. The method of claim 1, wherein the radio link failure information further includes fourth information indicating a time elapsed since the RLF is detected.

4. A method performed by a first base station associated with a target cell in a wireless communication system, the method comprising:
receiving, from a second base station, a first message including a radio link failure (RLF) report in case that radio link failure information is transmitted to the second base station;
detecting a cause for an RLF based on the first message; and
transmitting, to a third base station, a handover report including at least one of information on a cell radio network temporary identifier (C-RNTI) assigned by the target cell or information indicating a time elapsed since the RLF is detected.

5. The method of claim 4, further comprising:
receiving, from the second base station, a second message including a successful handover report in case that the successful handover report is transmitted to the second base station and a cause for the successful handover report is associated with the first base station, wherein the successful handover report includes at least one of information on a C-RNTI assigned by the target cell or information indicating a time elapsed since the RLF is detected; and
ignoring the successful handover report in case that the RLF report and the successful handover report are generated base on a same event.

6. A method performed by a second base station in a wireless communication system, the method comprising:
transmitting, to a terminal, a user equipment (UE) information request message;
receiving, from the terminal, a UE information response message including at least one of successful handover report or radio link failure information based on the UE information request message, wherein the successful handover report includes information on a cell radio network temporary identifier (C-RNTI) assigned by a target cell of a handover in case that the handover is completed and the radio link failure information includes the C-RNTI assigned by the target cell;
transmitting, to a first base station, a first message including a radio link failure (RLF) report including the radio link failure information;
determining whether the successful handover report is associated with the first base station or a third base station; and
transmitting, to the first base station, a second message including the RLF report including the successful handover report in case that the successful handover report is associated with the first base station.

7. The method of claim 6, further comprising:
transmitting, to the third base station, a third message including the RLF report including the successful handover report in case that the successful handover report is associated with the first base station.

8. The method of claim 6, wherein the successful handover report is ignored, by the first base station, in case that the RLF report and the successful handover report are generated base on a same event.

9. A terminal in a wireless communication system, the terminal comprising:
a transceiver; and
at least one processor operably coupled to the transceiver, the at least on processor configured to:
store a successful handover report including information on a cell radio network temporary identifier (C-RNTI) assigned by a target cell for a handover in case that the handover is completed,
identify that a radio link failure (RLF) is detected,
store, radio link failure information based on the RLF, the radio link failure information including the C-RNTI assigned by the target cell,
receive, from a base station via the transceiver, a user equipment (UE) information request message, and
transmit, to the base station, a UE information response message including at least one of the successful handover report or the radio link failure information in response to receiving the UE information request message.

10. The terminal of claim 9, wherein the handover is performed from a source cell associated with a new radio (NR) to a target cell associated with an evolved universal terrestrial radio access (E-UTRA),
wherein the successful handover report further includes at least one of first information indicating a time elapsed since an execution of a handover command, second information of the source cell, or third information of the target cell,
wherein the second information of the source cell comprises a global cell identity and a tracking area code of the source cell, and
wherein the third information of the target cell comprises a global cell identity and a tracking area code of the target cell.

11. The terminal of claim 9, wherein the radio link failure information further includes fourth information indicating a time elapsed since the RLF is detected.

12. A first base station associated with a target cell in a wireless communication system, the first base station comprising:
a transceiver; and
at least one processor operably coupled to the transceiver, the at least one processor configured to:
receive, from a second base station via the transceiver, a first message including a radio link failure (RLF) report in case that radio link failure information is transmitted to the second base station,
detect a cause for an RLF based on the first message, and
transmit, to a third base station via the transceiver, a handover report including at least one of information on a cell radio network temporary identifier (C-RNTI) assigned by the target cell or information indicating a time elapsed since the RLF is detected.

13. The first base station of claim 12, wherein the at least one processor is further configured to:
receive, from the second base station via the transceiver, a second message including a successful handover report, in case that the successful handover report is transmitted to the second base station and a cause for the successful handover report is associated with the first base station, wherein the successful handover report includes at least one of information on a C-RNTI assigned by the target cell, or information indicating a time elapsed since the RLF is detected, and
ignore the successful handover report in case that the RLF report and the successful handover report are generated base on a same event.

14. A second base station in a wireless communication system, the second base station comprising:
a transceiver; and
at least one processor configured to:
transmit to a terminal via the transceiver, a user equipment (UE) information request message,
receive, from the terminal via the transceiver, a UE information response message including at least one of successful handover report or radio link failure information based on the UE information request message, wherein the successful handover report includes information on a cell radio network temporary identifier (C-RNTI) assigned by a target cell of a handover in case that the handover is completed, and the radio link failure information includes the C-RNTI assigned by the target cell,
transmit, to a first base station, a first message including a radio link failure (RLF) report including the radio link failure information,
determine whether the successful handover report is associated with the first base station or a third base station, and
transmit, to the first base station, a second message including the RLF report including the successful handover report, in case that the successful handover report is associated with the first base station.

15. The second base station of claim 14, wherein the at least one processor is further configured to:
transmit, to the third base station, a third message including the RLF report including the successful handover report in case that the successful handover report is associated with the first base station.

16. The second base station of claim 14, wherein the successful handover report is ignored, by the first base station, in case that the RLF report and the successful handover report are generated base on a same event.
